(19) United States
(12) Patent Application Publication
(10) Pub. No.: US 2010/0294533 A1
(43) Pub. Date: Nov. 25, 2010

(54) Shielded electric wire and method of identifying shielded wire

(76) Inventors: Kiyoshi Yagi, Susono-shi (JP); Makoto Katsumata, Shizuoka (JP); Masashi Kitada, Shizuoka (JP); Kiyoshi Uchida, Toyoda-Shi (JP)

Correspondence Address: EDWARDS ANGELL PALMER & DODGE LLP, P.O. BOX 55874, BOSTON, MA, 02205, US

(21) Appl. No.: 12/311,859

(22) PCT Filed: Oct. 4, 2007
(86) PCT No.: PCT/JP2007/069889

§ 371 Date: Apr. 16, 2009

(30) Foreign Application Priority Data
Oct. 19, 2006 (JP) 2006-284664

(51) Int. Cl. H01B 7/36; G01D 13/00

(52) U.S. Cl. 174/112; 116/201

(57) ABSTRACT

A shielded electric wire 1A is composed of a plurality of covered electric wires 10 of which core wires 2 are covered by covers having different colors; a braided shield 4 attached to an outer region of the covered electric wires 10; and an insulating sheath 5 covering an outer circumference of the braided shield 4. Because the covered electric wires 10 have covers 3 having different colors, the covered electric wires 10 can be identified from each other. Further, a mark 6A for identifying the electric wire is formed on a part of the outer surface of the sheath 5. A color identifying a destination of each covered electric wire 10 is selected properly as the color of the mark 6A. Further, a combination of the colors of the covers 3 of the covered electric wires 10 and the color of the mark 6A can indicate a product type of the shielded electric wire 1A.

### TECHNICAL FIELD

This invention relates to a shielded wire including: a plurality of covered electric wires, of which conductive core wires are covered by covers; a metallic shield member attached to an outer region of the covered wires; and a sheath covering an outer circumference of the shield member, and to a method of identifying the shielded wire.

### BACKGROUND

A wiring harness is arranged in a vehicle for supplying electricity to electric components such as various lamps or various motors from a battery, or for sending control signals from a controller. The wiring harness includes a plurality of electric wires, and terminal fittings attached to ends of the electric wires. Sometimes, a shielded wire is used as the electric wires composing the wiring harness (shown in FIG. 4, and see Patent Document 1).

The shielded electric wire 101 shown in FIG. 4 includes: a plurality of covered electric wires 120 of which conductive core wires 102 are covered by insulating covers 103; a braided shield 104 attached to an outer region of the covered electric wires 120; and an insulating sheath covering an outer circumference of the braided shield 104. By bypassing extrinsic noise to be mixed into the covered electric wires 120 to the ground via the braided shield 104, the shielded electric wire 101 prevents the core wires 102 of the covered electric wires 120 from being mixed with extrinsic noise.

For identifying the covered electric wires 120 of the shielded electric wire 101 (for identifying the same covered electric wire 120 at both ends of the shielded electric wire 101), colors of the covers 103 are different from each other. Further, for identifying destinations of the covered electric wires 120, identifying marks 106 (a stripe mark in FIG. 4) different from color of the outer surfaces of the covers 103 are formed on the outer surfaces of the covers 103. [Patent Document 1] Japanese Published Patent Application No. 2005-174767

### DISCLOSURE OF THE INVENTION

### [Problem to be Solved by the Invention]

Nowadays, users want a vehicle to have various electronic components, and the number of types of the shielded electric wire 101 is increased. Therefore, a space and manpower to hold a wide variety of the covered electric wires 120 and the shielded electric wire 101 is needed in a factory for producing the covered electric wires 120 or an assembly factory for the shielded electric wire 101. Further, a troublesome operation is needed for managing the covered electric wires 120 and the shielded electric wire 101. Therefore, a cost of the shielded electric wire 101 increases.

Accordingly, an object of the present invention is to provide a shielded electric wire, and a method of identifying the shielded electric wire to allow a cost of the shielded wire to be reduced.

### [Means for Solving Problem]

For attaining the object, according to claim 1 of the present invention, there is provided a shielded electric wire including:

a plurality of covered electric wires, of which conductive core wires are covered by covers having different colors;

a metallic shield member attached to an outer region of the covered wires; and

a sheath covering an outer circumference of the shield member,

wherein a mark for identifying the shielded electric wire is formed on an outer surface of the sheath.

According to claim 2 of the present invention, there is provided the shielded electric wire as claimed in claim 1,

wherein the mark is formed by coloring a part of the outer surface of the sheath.

According to claim 3 of the present invention, there is provided a method of identifying a shielded electric wire,

said electric wire including:

a plurality of covered electric wires, of which conductive core wires are covered by covers having different colors;

a metallic shield member attached to an outer region of the covered wires; and

a sheath covering an outer circumference of the shield member, said method including the steps of

coloring a part of an outer surface of the sheath to form a mark,

identifying the covered electric wires by colors of the covers of the covered electric wires;

identifying destinations to be connected by a color of the mark; and

identifying product types by a combination of colors of the covers and the color of the mark.

Incidentally, coloring the outer surface of the sheath according to the present invention means that coloring the outer surface of the sheath with a coloring material. The coloring material means a liquid substance, in which a coloring material (organic substance for use in industry) is dissolved and dispersed in water or other solvent. The organic substance described above is a dye or a pigment (most of them being organic substances and synthetic substances). Sometimes, a dye is used as a pigment and a pigment is used as a dye. As a more concrete example, the coloring material is a coloring liquid or coating material. The coloring liquid is a liquid, in which a dye is dissolved or dispersed in a solvent. The coating material is a material, in which a pigment is dispersed in a liquid dispersion. When the coloring liquid is deposited on the outer surface of the sheath, the dye permeates into the sheath. When the coating material is deposited on the outer surface of the sheath, the pigment is deposited on the outer surface without permeating into the sheath. Thus, “to color the outer surface of the sheath” means to dye a part of the outer surface of the sheath with a dye or to coat a part of the outer surface of the sheath with a pigment. Preferably, the solvent and liquid dispersion have an affinity to the synthetic resin that constitutes the sheath in order to securely permeate the dye into the sheath or to allow the pigment to securely be deposited on the outer surface of the sheath.

### [Effect of the Invention]

According to the present invention as claimed in claim 1, because the covered electric wires include the covers having colors different from each other, the covered electric wires are allowed to be identified. Further, owing to the color of the mark, the destinations of the covered electric wires are allowed to be identified. Further, owing to the combination of the colors of the covers and the color of the mark, the product types are allowed to be identified. Further, after producing the shielded electric wires of which outer surfaces of the sheaths are the same color, by changing properly the colors of the marks formed on the outer surfaces of the sheathes, various shielded electric wires can be produced. Therefore, a stock of the covered electric wires and the shielded electric wires in the factory for producing the covered electric wires and the assembly factory for the shielded electric wire can be reduced. Thus, the cost of the shielded electric wire can be reduced.

According to the present invention as claimed in claim 2, by changing properly the colors of the coloring material for forming the mark, various shielded electric wires can be produced.

According to the present invention as claimed in claim 3, the covered electric wires can be identified from each other with the colors of the covers which are different from each other. Further, owing to the color of the mark formed on the outer surface of the sheath, the destination of the covered electric wire can be identified. Further, owing to the combination of the colors of the covers and the color of the mark, the product types are allowed to be identified. Further, by changing properly the colors of the coloring material for forming the marks, various shielded electric wires can be produced.

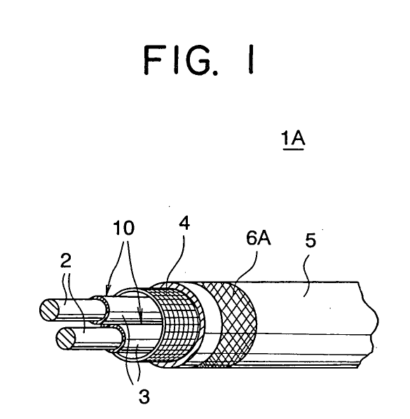

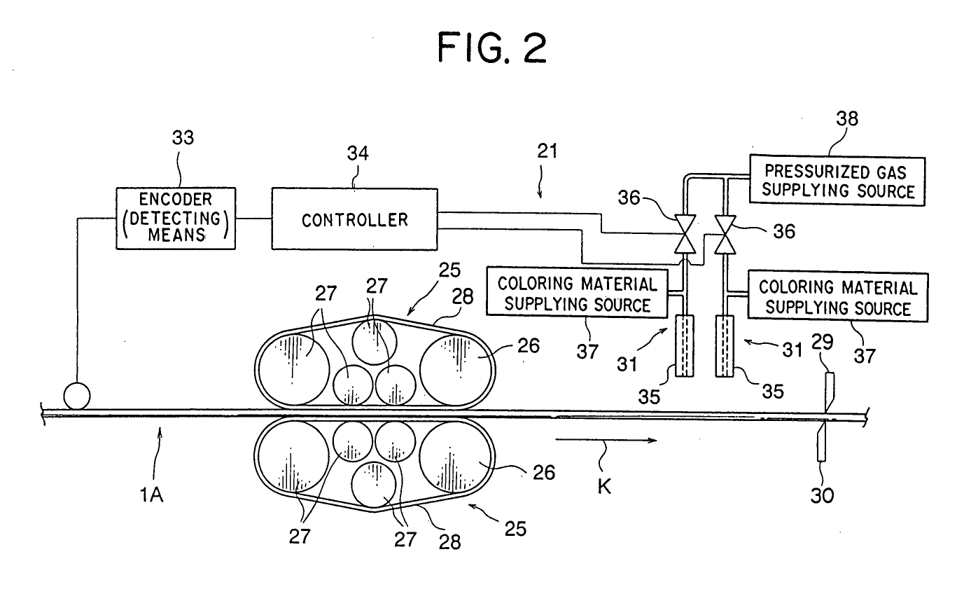

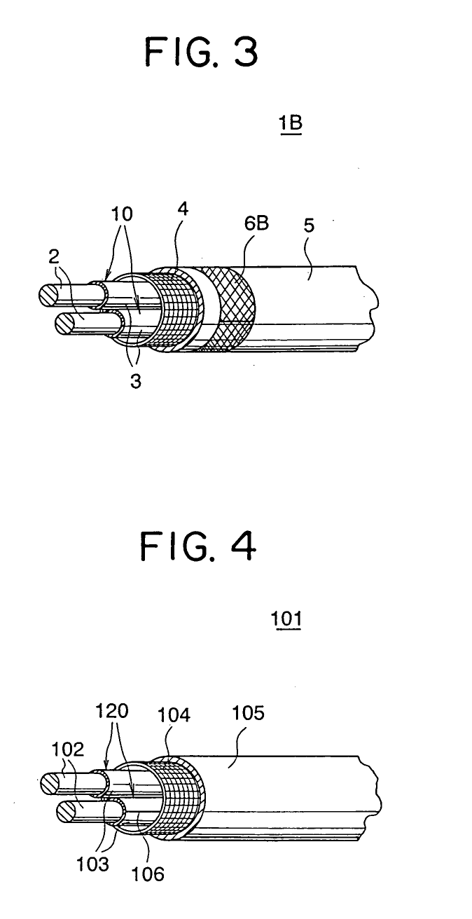

### [BRIEF DESCRIPTION OF DRAWINGS]

[FIG. 1] a perspective view showing a shielded electric wire according to a first embodiment of the present invention.

[FIG. 2] an explanatory view showing a machine for coloring a mark for identifying an electric wire formed on a sheath of the shielded electric wire shown in FIG. 1.

[FIG. 3] a perspective view showing a shielded electric wire according to a second embodiment of the present invention.

[FIG. 4] a perspective view showing a conventional shielded electric wire.

### EXPLANATIONS OF LETTERS OR NUMERALS

1A, 1B shielded electric wire

2 core wire

3 cover

4 braided shield (shield member)

5 sheath

6A, 6B mark

10 covered electric wire

### BEST MODE FOR CARRYING OUT THE INVENTION

Hereafter, a shielded electric wire and a method of identifying the shielded electric wire according to a first embodiment of the present invention will be explained with reference to FIGS. 1 and 2.

As shown in FIG. 1, a shielded electric wire 1 is composed of a plurality (two in FIG. 1) of covered electric wires 10, a braided shield 4 as a metallic shield member attached to an outer region of the covered electric wires 10, and an insulating sheath 5 covering an outer circumference of the braided shield 4.

Each covered electric wire 10 includes a conductive core wire 2 and an insulating cover 3. The core wire 2 is made of a strand of elemental wires. The elemental wire composing the core wire 2 is made of conductive metal. The core wire 2 may be composed of a single elemental wire. The cover 3 is made of synthetic resin such as polyvinyl chloride (PVC). The cover 3 covers the core wire 2.

An outer surface of the cover 3 is colored in monochrome. The outer surfaces of the covers of the covered electric wires 10 are colored in colors different from each other. The outer surface of the cover 3 may be colored in monochrome by mixing the synthetic resin of the cover 3 with a desired coloring material. Alternatively, the outer surface of the cover 3 may be colored by not mixing the coloring material but the color of the synthetic resin may be the desired color. Thus, because the covered electric wires 10 have covers 3 having different colors, the covered electric wires 10 can be identified from each other. Further, because both ends of one covered electric wire 10 have the same color, by selecting the same color, both ends of the one covered electric wire 10 can be easily selected. Thus, a wiring operation can be surely carried out without wrong selection.

The sheath 5 is made of synthetic resin such as polyvinyl chloride (PVC). An outer surface of the sheath 5 is colored in monochrome. The outer surface of the sheath 5 may be colored in monochrome by mixing the synthetic resin of the sheath 5 with a desired coloring material. Alternatively, the outer surface of the sheath 5 may be colored by not mixing the coloring material but the color of the synthetic resin may be the desired color. The outer surface of the sheath 5 may be the same color as any one of the covers 3 of the covered electric wires 10.

Further, a mark 6A for identifying the electric wire is formed on a part of the outer surface of the sheath 5. This mark 6A is formed on an end of the shielded electric wire 1A, and formed on a whole circumference of the sheath 5. Further, the mark 6A is colored by a color different from the color of the outer surface of the sheath 5.

The color of the mark 6A of the shielded electric wire 1A is properly changed. The colors of the mark 6A indicate destinations of the covered electric wires 10.

Further, a combination of the colors of the covers 3 of the covered electric wires 10 and the color of the mark 6A can indicate a product type of the shielded electric wire 1A.

As shown in FIG. 2, a marking machine 21 is used for forming the mark 6A. As shown in FIG. 2, the marking machine 21 is mounted on an electric wire cutting machine 20.

As shown in FIG. 2, the electric wire cutting machine 20 includes a main body installed on a floor of a factory, a measuring system 23, and a cutting system 24. The main body 22 is formed in a box shape. The measuring system 23 includes a pair of belt feeding units 25.

Each belt feeding unit 25 includes a driving pulley 26, a plurality of driven pulleys 27, and an endless belt 28. The driving belt 26 is rotated by a motor as a driving force received in the main body 22. Each driven pulley 27 is rotatably supported by the main body 22. The endless belt 28 is a ring-shaped (endless) belt, and carried across the driving pulley 26 and the driven pulleys 27. The endless belt 28 rotates around the pulleys 26, 27.

The pair of belt feeding units 25 is arranged vertically. The pair of belt feeding units 25 catches the shielded electric wire 1A therebetween, and by rotating the driving pulleys 26 at the same period, rotates the endless belt 28 to feed a specific length of the shielded electric wire 1A.

At this time, the pair of belt feeding units 25 moves the shielded electric wire 1A. in a direction of an arrow K in FIG. 2 parallel to a longitudinal direction of the shielded electric wire 1A.

The cutting system 24 is disposed at a downstream of the arrow K direction of the pair of belt feeding units 25. The cutting system 24 includes a pair of cutting blades 29, 30. The pair of cutting blades 29, 30 is arranged vertically. Namely, the pair of cutting blades 29, 30 approaches and moves away from each other. When the pair of cutting blades 29, 30 approaches each other, the pair of cutting blades 29, 30 catches the shielded electric wire 1A fed by the pair of belt feeding units 25 therebetween, and cuts. When the pair of cutting blades 29, 30 moves away from each other, the pair of cutting blades 29, 30 also moves away from the shielded electric wire 1A.

In the electric wire cutting machine 20, the pair of belt feeding units 25 catches the shielded electric wire 1A while the pair of cutting blades 29, 30 moves away from each other, and feeds the shielded electric wire 1A in the arrow K direction. After feeding a specific length of the shielded electric wire 1A, the driving pulley 26 of the pair of belt feeding units 25 stops. Then, the pair of cutting blades 29, 30 approaches each other, catches and cut the shielded electric wire 1A. Then, the electric wire cutting machine 20 moves the shielded electric wire 1A along the arrow K.

The marking machine 21 is used for forming the mark 6A on the outer surface of the shielded electric wire 1A, namely, on the outer surface of the sheath 5. The marking machine 21 includes a plurality of coloring units 31, an encoder 33 as a detecting means, and a controller 34. In FIG. 2, two coloring units 31 are used. The coloring units 31 are arranged along the arrow K.

The coloring units 31 are interposed between the pair of belt feeding units 25 of the measuring system 23 and the pair of cutting blades 29, 30 of the cutting system 14. Each coloring unit 31 includes a nozzle 35 and a valve 36. The nozzle 35 faces the shielded electric wire 1A moved along the arrow K by the pair of belt feeding units 25. A coloring material supplying source 37 supplies coloring material having a specific color into the nozzle 35.

The valve 36 is connected to the nozzle 35. Further, a pressurized gas supplying source 38 is connected to the valve 36. The pressurized gas supplying source 38 supplies a pressurized gas to the nozzle 35 via the valve 36. When the valve 36 is open, the coloring material in the nozzle 35 is spouted toward the outer surface of the shielded electric wire 1A by the pressurized gas supplied from the pressurized gas supplying source 38.

When the valve 36 is closed, the spout of the coloring material from the nozzle 35 stops. Owing to the structure described above, in the coloring units 31, a signal from the controller 34 opens the valve 36 in a predetermined time, so that a specific amount of the coloring material having the specific color is spouted toward the outer surface of the shielded electric wire 1A.

The coloring material described above means a liquid substance, in which a coloring material (organic substance for use in industry) is dissolved and dispersed in water or other solvent. The organic substance described above is a dye or a pigment (most of them being organic substances and synthetic substances). Sometimes, a dye is used as a pigment and a pigment is used as a dye. As a more concrete example, the coloring material is a coloring liquid or coating material.

The coloring liquid is a liquid, in which a dye is dissolved or dispersed in a solvent. The coating material is a material, in which a pigment is dispersed in a liquid dispersion. When the coloring liquid is deposited on the outer surface of the shielded electric wire 1A, the dye permeates into the sheath 5. When the coating material is deposited on the outer surface of the shielded electric wire 1A, the pigment is deposited on the outer surface without permeating into the sheath 5.

Namely, the coloring units 31 dye a part of the outer surface of the shielded electric wire 1A with a dye, or coat a part of the outer surface of the shielded electric wire 1A with a pigment. Thus, “to color the outer surface of the shielded electric wire 1A” means to dye a part of the outer surface of the shielded electric wire 1A with a dye or to coat a part of the outer surface of the sheath with a pigment.

Preferably, the solvent and liquid dispersion have an affinity to the synthetic resin that constitutes the sheath 5 in order to securely permeate the dye into the sheath 5 or to allow the pigment to securely be deposited on the outer surface of the sheath 5.

The encoder 33 measures data based on a movement and a moving speed of the shielded electric wire 1A, and outputs the data to the controller 34. The controller 34 is a well-known computer including ROM, RAM, and CPU, connected to the encoder 33, the valve 36, and the like, to control the whole of the marking machine 21.

The controller 34 stores the length of the mark 6A formed on the outer surface of the shielded electric wire 1A. Namely, the controller 34 stores a pattern of the mark 6A formed on the outer surface of the shielded electric wire 1A.

The controller 34 stores an interval between the nozzles 35 of the coloring units 31. For forming the mark 6A on the outer surface of the shielded electric wire 1A, the controller 34 opens/closes the valve 36 according to the data from the encoder 33 so that the nozzle 35 of the coloring unit 31 spouts the coloring material.

When the marking machine 21 forms the mark 6A on the outer surface of the shielded electric wire 1A, namely, colors the outer surface of the shielded electric wire 1A, the pair of belt feeding units 25 of the electric wire cutting machine 20 moves the shielded electric wire 1A along the arrow K.

Then, the controller 34 controls the valve 36 and the like, and the nozzle 35 of each coloring unit 31 spouts a specific amount of the coloring material toward the outer surface of the shielded electric wire 1A. Thus, the mark 6A with a specific pattern is formed on the outer surface of the shielded electric wire 1A.

Then, the pair of belt feeding units 25 of the electric wire cutting machine 20 feeds a specific length of the shielded electric wire 1A, and stops. The pair of cutting blades 29, 30 of the cutting system 24 cuts the shielded electric wire lA on which the mark 6A is formed. Thus, the shielded electric wire 1A on which the mark 6A is formed as shown in FIG. 1 is attained.

According to this embodiment, because the covers 3 having different colors composes the covered electric wires 10, the covered electric wires 10 can be identified from each other. Further, owing to the color of the mark 6A, the destinations of the covered electric wires 10 can be identified from each other. Further, owing to the combination of the colors of the covers 3 and the color of the mark 6A, the product types are allowed to be identified. Further, after producing the shielded electric wires lA of which outer surfaces of the sheaths 5 are the same color, by changing properly the colors of the marks 6A formed on the outer surfaces of the sheathes 5, various shielded electric wires 1A can be produced. Therefore, a stock of the covered electric wires 10 and the shielded electric wires 1A in the factory for producing the covered electric wires 10 and the assembly factory for the shielded electric wire 1A can be reduced. Thus, the cost of the shielded electric wire 1A can be reduced.

Next, a shielded electric wire and a method of identifying the shielded electric wire according to a second embodiment of the present invention will be explained with reference to FIG. 3. In FIG. 3, the same members therein as those of the first embodiment are designated by the same reference characters, and explanations thereof are omitted.

As shown in FIG. 3, in a shielded electric wire 1B according to this embodiment, a mark 6B for identifying the wire is formed on the outer surface of the sheath 5. This mark 6B is formed on an end of the shielded electric wire 1B, and formed on the whole circumference of the sheath 5. Further, the mark 6B is made of a tape having a color different from the color of the outer surface of the sheath 5 and wound around the outer circumference of the sheath 5.

Similar to the first embodiment described above, the color of the mark 6B of the shielded electric wire 1B is properly changed. The color of the mark 6B indicates the destination of the covered electric wire 10.

Thus, according to the present invention, the mark for identifying the electric wire can be formed except by coloring.

Further, according to the present invention, as the coloring liquid or coating material, various materials may be used, such as acrylic coating material, ink (dye or pigment) and UV-ink.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A shielded electric wire comprising:
a plurality of covered electric wires, of which conductive core wires are covered by covers having different colors;
a metallic shield member attached to an outer region of the covered wires; and
a sheath covering an outer circumference of the shield member,
wherein a mark for identifying the shielded electric wire is formed on an outer surface of the sheath.

2. The shielded electric wire as claimed in claim 1,
wherein the mark is formed by coloring a part of the outer surface of the sheath.

3. A method of identifying a shielded electric wire, said electric wire including:
a plurality of covered electric wires, of which conductive core wires are covered by covers having different colors;
a metallic shield member attached to an outer region of the covered wires; and
a sheath covering an outer circumference of the shield member,
said method comprising the steps of
coloring a part of an outer surface of the sheath to form a mark,
identifying the covered electric wires by colors of the covers of the covered electric wires;
identifying destinations to be connected by a color of the mark; and
identifying product types by a combination of colors of the covers and the color of the mark.
